(19) United States
(12) Patent Application Publication
(10) Pub. No.: US 2023/0310906 A1
(43) Pub. Date: Oct. 5, 2023

(54) MASK USING OXYGEN SUPPLY DEVICE

(71) Applicant: FILOS CO., LTD., Daejeon (KR)

(72) Inventor: Cheol Seung KIM, Incheon (KR)

(73) Assignee: FILOS CO., LTD., Daejeon (KR)

(21) Appl. No.: 18/042,429

(22) PCT Filed: Jun. 17, 2021
(86) PCT No.: PCT/KR2021/007603

§ 371 Date: Feb. 21, 2023

(30) Foreign Application Priority Data
Sep. 17, 2020 (KR) 10-2020-0119819

(51) Int. Cl. A62B 7/04; A62B 7/12; A62B 9/04; A62B 18/02; A62B 9/02

(52) U.S. Cl. CPC A62B 7/04; A62B 7/12; A62B 9/04; A62B 18/025; A62B 9/022

(57) ABSTRACT

Proposed is a mask using an oxygen supply device. The mask includes a purification cartridge which purifies air for breathing, a mask part which introduces and discharges the air purified via the purification cartridge, a connector which fastens together the purification cartridge and the mask part, and an oxygen supply device which supplies oxygen through an oxygen hose connected to the connector.

### TECHNICAL FIELD

The present disclosure relates to a mask using an oxygen supply device and, more particularly, to a mask that allows a wearer to breathe using ambient air at normal times and to receive oxygen along with the ambient air by installing an oxygen supply device in situations of oxygen deprivation or breathing difficulties.

### BACKGROUND ART

In general, a breathing mask or respirator is used to prevent the inflow of toxic gas and dust, and a wearer inhales only the air purified using an air-purifying element (e.g., filter cartridge).

Yet, in the case of a breathing mask equipped with a filter cartridge, there is no oxygen supply device, and thus a user has no way to cope with situations where oxygen concentration is low or breathing difficulties occur. In order to solve this problem, a breathing mask with an integrated oxygen supply device has been introduced recently, but the problem in this case is that the mask cannot be used alone.

Such oxygen supply device is used by making a hole in the upper part of an oxygen can with a perforated pin by means of a regulator.

However, in the conventional oxygen supply device, the oxygen supply cannot be stopped until the oxygen in the oxygen can is exhausted, so a user may not selectively use oxygen, and since there is no orifice to precisely control the flow rate, the operating time is short and oxygen is excessively supplied, which is inefficient.

(Patent Document 001) Korean Patent No. 1699514 (Jan. 18, 2017 “OXYGEN BREATHING APPARATUS FOR EMERGENCY”)

### DISCLOSURE

### Technical Problem

The present disclosure has been made keeping in mind the problems occurring in the related art. An objective of the present disclosure is to provide a mask using an oxygen supply device, which can be used for a long time without interfering with breathing by having a regulator capable of stopping and precisely supplying high-pressure oxygen stored in an oxygen can.

In addition, an objective of the present disclosure is to provide a mask using an oxygen supply device, which can supply oxygen along with ambient air by installing the oxygen supply device in situations of oxygen deprivation or breathing difficulties.

### Technical Solution

In order to achieve the above mentioned objective, according to an embodiment of the present disclosure, there is provided a mask using an oxygen supply device, including: a purification cartridge which purifies air for breathing; a mask part which introduces and discharges the air purified via the purification cartridge; a connector which fastens together the purification cartridge and the mask part; and an oxygen supply device which supplies oxygen through an oxygen hose connected to the connector.

The connector may be provided with fastening portions at predetermined intervals on an inner circumferential surface of an upper end of a body thereof, wherein each fastening portion may include: a locking jaw that restricts a rotation of a coupling protrusion of the mask part when the coupling protrusion rotates; and a stopper famed to protrude from one end of a lower end of the locking jaw to limit the rotation of the coupling protrusion of the mask part, and the connector may have a hose connection part to which the oxygen hose is connected on one side of the body.

The mask part and the connector may be combined when three coupling protrusions on a side of the mask part are inserted into three insertion grooves on an upper part of a body of the connector and then rotated, so that the coupling protrusions of the mask part may be fixed to fastening portions of the connector.

The connector and the purification cartridge may be fastened when three coupling protrusions on a lower part of a body of the connector are inserted into three insertion grooves of the purification cartridge and then rotated, so that the coupling protrusions of the connector may be fixed to fastening portions of the purification cartridge.

The oxygen supply device may constantly supply high-pressure oxygen in an amount that a user is able to breathe by means of a regulator coupled to an oxygen can.

The regulator may include: a body part coupled with the oxygen can; a handle part configured to turn on or off the oxygen supply of the oxygen can; a pressing plate configured to contact a pin of the oxygen can by rotating the handle part; and a fitting connection part coupled to one side of the body part.

The body part may have a cylindrical shape with a concave central portion, and may be screwed together while surrounding an outer circumferential surface of an upper part of the oxygen can.

In an opening on a side of the body part, after inserting an orifice, the fitting connection part may be screwed.

Inside the body part, a sealing member may be inserted into a portion in contact with an upper end of the oxygen can to prevent oxygen leakage, wherein the sealing member may be fixed with a fixing screw.

The handle part may be coupled with threads on an upper outer circumferential surface of the body part, and may always rotate by a certain amount due to a set screw.

When the handle part is rotated left and right, the pressing plate inside the body part may move up and down, making contact with or not contacting the pin of the oxygen can, so that an oxygen supply may be turned on or off.

When a gap adjustment part coupled with threads on an inner surface of the handle part is adjusted up and down using a gap adjustment screw, the pressing plate may move up and down by a pressure-reducing spring to adjust a gap between the oxygen can and the pin.

Oxygen supplied by means of the pin of the oxygen can may be stored in an oxygen tank located between the pressing plate and the sealing member inside the body part, depressurized by means of the pressure-reducing spring and the orifice, and discharged to the fitting connection part.

The orifice may be formed with a central hole having a diameter of 0.05 mm to 0.1 mm.

### Advantageous Effects

As described above, according to the present disclosure, due to a regulator, oxygen stored in a high-pressure oxygen can be supplied to a mask at a low pressure and constant flow rate, and oxygen can be supplied and blocked, thereby improving user safety and convenience.

Moreover, according to the present disclosure, by connecting a connector for oxygen supply between the mask and a purification cartridge, it is possible for a user to breathe using ambient air at normal times and to receive oxygen along with the ambient air by operating the regulator of an oxygen supply device in situations of oxygen deprivation or breathing difficulties, allowing the user to breathe safely and comfortably.

Furthermore, according to the present disclosure, the connector for oxygen supply can be selectively used according to the shape of a fastening portion of the purification cartridge so as to be universally applied for general breathing masks such as half-face, full-face, and hood-type masks.

### DESCRIPTION OF DRAWINGS

FIG. 1 is a configuration view of a mask using an oxygen supply device according to the present disclosure;

FIG. 2 shows a plan perspective view (FIG. 2a) and a bottom perspective view (FIG. 2b) of a connector for oxygen supply according to the present disclosure; and

FIG. 3 is a cross-sectional view of an oxygen supply device according to the present disclosure.

### BEST MODE

Hereinafter, embodiments of the present disclosure will be described in detail with reference to the accompanying drawings, so that those skilled in the art can easily carry out the present disclosure. However, the present disclosure may be embodied in many different forms and is not limited to the embodiments described herein.

Then, a preferred embodiment of a mask using an oxygen supply device according to the present disclosure will be described in detail.

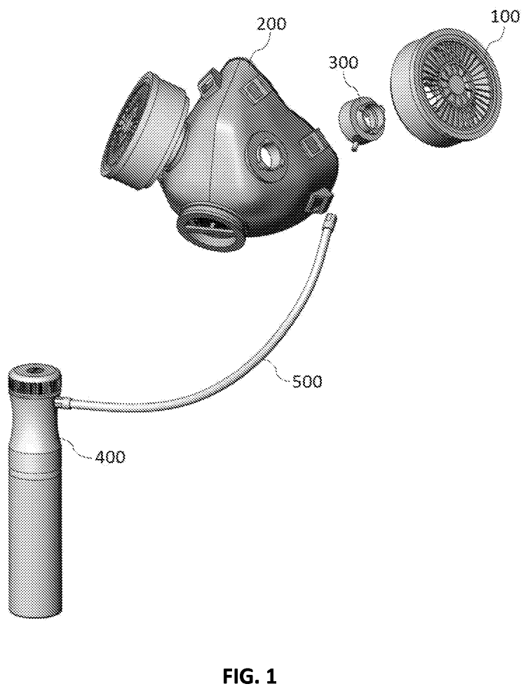

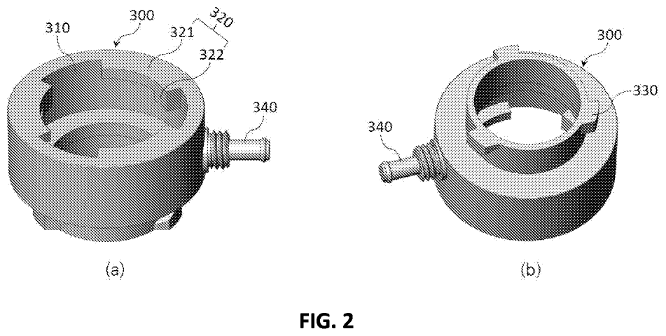

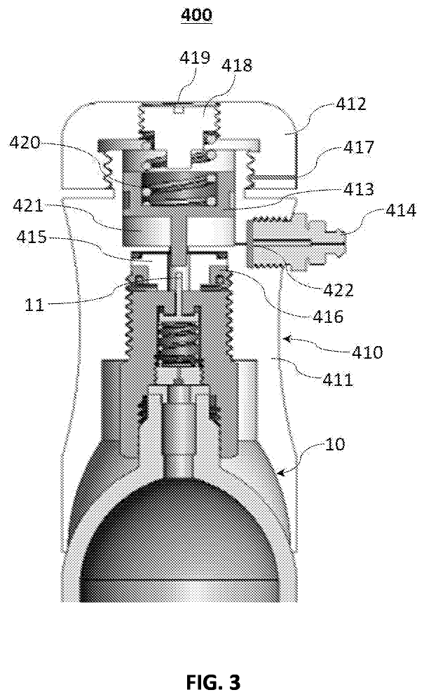

FIG. 1 is a configuration view of a mask using an oxygen supply device according to the present disclosure; FIG. 2 shows a plan perspective view (FIG. 2a) and a bottom perspective view (FIG. 2b) of a connector for oxygen supply according to the present disclosure; and FIG. 3 is a cross-sectional view of an oxygen supply device according to the present disclosure.

Referring to FIGS. 1 to 3, the mask using an oxygen supply device according to the present disclosure includes: a purification cartridge 100 which purifies air for breathing, a mask part 200 which introduces and discharges the air purified via the purification cartridge 100, a connector 300 which fastens together the purification cartridge 100 and the mask part 200, and an oxygen supply device 400 which supplies oxygen through an oxygen hose 500 connected to the connector 300.

The mask part 200 prevents the inhalation of harmful gases by means of the purification cartridge 100 and introduces and discharges air so that breathing takes place.

The connector 300 fastens the mask part 200 and the purification cartridge 100 to the upper and lower ends of a cylindrical body thereof, respectively.

The connector 300 is provided with fastening portions 320 at predetermined intervals on the inner circumferential surface of the upper end of the body, and each fastening portion 320 is composed of: a locking jaw 321 that restricts the rotation of a coupling protrusion of the mask part 200 when the coupling protrusion rotates; and a stopper 322 foiled to protrude from one end of the lower end of the locking jaw 321 to limit the rotation of the coupling protrusion of the mask part 200.

In addition, the connector 300 has a hose connection part 340 to which the oxygen hose 500 is connected on one side of the body.

The mask part 200 and the connector 300 are combined when the three coupling protrusions on the side of the mask part 200 are inserted into three insertion grooves 310 on the upper part of the body of the connector 300 and then rotated, so that the coupling protrusions of the mask part 200 are fixed to the fastening portions 320 of the connector 300. That is, the mask part 200 and the connector 300 are fastened and coupled to each other when the three coupling protrusions on the side of the mask part 200 are inserted into the three insertion grooves 310 on the upper part of the body of the connector 300 and rotated, so that the coupling protrusions of the mask part 200 are fixed to the lower surfaces of the locking jaws 321 and the stoppers 322 of the fastening portions 320.

In addition, the connector 300 and the purification cartridge 100 are fastened and coupled to each other when three coupling protrusions 330 on the lower part of the body of the connector 300 are inserted into three insertion grooves of the purification cartridge 100 and rotated, so that the coupling protrusions 330 of the connector 300 are fixed to fastening portions of the purification cartridge 100.

At this time, when the fastening portions of the purification cartridge 100 are threaded, the connector 300 is screwed, and the connector 300 may be selectively used according to the shape of the fastening portion of the purification cartridge 100 without being limited thereto.

The oxygen supply device 400 may constantly supply high-pressure oxygen in an amount that a user can breathe by means of a regulator 410 coupled to an oxygen can 10.

The regulator 410 includes: a body part 411 coupled with the oxygen can 10; a handle part 412 for turning on or off the oxygen supply of the oxygen can 10; a pressing plate 413 for contacting a pin 11 of the oxygen can 10 by rotating the handle part 412; and a fitting connection part 414 coupled to one side of the body part 411.

The body part 411 has a cylindrical shape with a concave central portion, and is screwed together while surrounding the outer circumferential surface of the upper part of the oxygen can 10.

In the opening on one side of the body part 310, after inserting an orifice 422, the fitting connection part 414 is screwed.

Inside the body part 411, a sealing member 415 may be inserted into a portion in contact with the upper end of the oxygen can 10 to prevent oxygen leakage. At this time, the sealing member 415 is fixed with a fixing screw 416.

The handle part 412 is coupled with threads on the upper outer circumferential surface of the body part 411, and always rotates by a certain amount due to a set screw 417.

When the handle part 412 is rotated left and right, the pressing plate 413 inside the body part 411 moves up and down, making contact with or not contacting the pin 11 of the oxygen can 10, thereby turning on or off the supply of oxygen.

Meanwhile, when a gap adjustment part 418 coupled with threads on the inner surface of the handle part 412 is adjusted up and down using a gap adjustment screw 419, the pressing plate 413 is moved up and down by a pressure-reducing spring 420 to adjust the gap between the oxygen can 10 and the pin 11. At this time, when the gap between the pressing plate 413 and the pin 11 is narrow, the pressure of the pressing plate 413 pressing the pin 11 of the oxygen can 10 is high, and the amount of oxygen supplied increases.

Oxygen supplied through the pin 11 of the oxygen can 10 is stored in an oxygen tank 421 located between the pressing plate 413 and the sealing member 415 inside the body part 411, is depressurized by means of the pressure-reducing spring and the orifice 422, and is discharged to the fitting connection part 414. At this time, the fitting connection part 414 is connected to the oxygen hose 500.

The orifice 422 is formed with a central hole having a diameter of 0.05 mm to 0.1 mm, preferably 0.08 mm to 0.09 mm, so that the use time may be about 40 minutes based on a 100 cc oxygen can.

Although the embodiments of the present disclosure have been described in detail above, the scope of the present disclosure is not limited thereto, and various modifications and improvements made by those skilled in the art using the basic concept of the present disclosure defined in the following claims also fall within the scope of the present disclosure.

1. A mask using an oxygen supply device, the mask comprising:
a purification cartridge which purifies air for breathing;
a mask part which introduces and discharges the air purified via the purification cartridge;
a connector which fastens together the purification cartridge and the mask part; and
an oxygen supply device which supplies oxygen through an oxygen hose connected to the connector.

2. The mask using an oxygen supply device of claim 1, wherein the connector is provided with fastening portions at predetermined intervals on an inner circumferential surface of an upper end of a body thereof,
wherein each fastening portion comprises:
a locking jaw that restricts a rotation of a coupling protrusion of the mask part when the coupling protrusion rotates; and
a stopper formed to protrude from one end of a lower end of the locking jaw to limit the rotation of the coupling protrusion of the mask part, and
the connector has a hose connection part to which the oxygen hose is connected on one side of the body.

3. The mask using an oxygen supply device of claim 1, wherein the mask part and the connector are combined when three coupling protrusions on a side of the mask part are inserted into three insertion grooves on an upper part of a body of the connector and then rotated, so that the coupling protrusions of the mask part are fixed to fastening portions of the connector.

4. The mask using an oxygen supply device of claim 1, wherein the connector and the purification cartridge are fastened when three coupling protrusions on a lower part of a body of the connector are inserted into three insertion grooves of the purification cartridge and then rotated, so that the coupling protrusions of the connector are fixed to fastening portions of the purification cartridge.

5. The mask using an oxygen supply device of claim 1, wherein the oxygen supply device constantly supplies high-pressure oxygen in an amount that a user is able to breathe by means of a regulator coupled to an oxygen can.

6. The mask using an oxygen supply device of claim 5, wherein the regulator comprises:
a body part coupled with the oxygen can;
a handle part configured to turn on or off the oxygen supply of the oxygen can;
a pressing plate configured to contact a pin of the oxygen can by rotating the handle part; and
a fitting connection part coupled to one side of the body part.

7. The mask using an oxygen supply device of claim 6, wherein the body part has a cylindrical shape with a concave central portion, and is screwed together while surrounding an outer circumferential surface of an upper part of the oxygen can.

8. The mask using an oxygen supply device of claim 6, wherein in an opening on a side of the body part, after inserting an orifice, the fitting connection part is screwed.

9. The mask using an oxygen supply device of claim 6, wherein inside the body part, a sealing member is inserted into a portion in contact with an upper end of the oxygen can to prevent oxygen leakage,
wherein the sealing member is fixed with a fixing screw.

10. The mask using an oxygen supply device of claim 6, wherein the handle part is coupled with threads on an upper outer circumferential surface of the body part, and always rotates by a certain amount due to a set screw.

11. The mask using an oxygen supply device of claim 6, wherein when the handle part is rotated left and right, the pressing plate inside the body part moves up and down, making contact with or not contacting the pin of the oxygen can, so that an oxygen supply is turned on or off.

12. The mask using an oxygen supply device of claim 6, wherein when a gap adjustment part coupled with threads on an inner surface of the handle part is adjusted up and down using a gap adjustment screw, the pressing plate moves up and down by a pressure-reducing spring to adjust a gap between the oxygen can and the pin.

13. The mask using an oxygen supply device of claim 6, wherein oxygen supplied by means of the pin of the oxygen can is stored in an oxygen tank located between the pressing plate and the sealing member inside the body part, is depressurized by means of the pressure-reducing spring and the orifice, and is discharged to the fitting connection part.

14. The mask using an oxygen supply device of claim 8, wherein the orifice is formed with a central hole having a diameter of 0.05 mm to 0.1 mm.

15. The mask using an oxygen supply device of claim 13, wherein the orifice is formed with a central hole having a diameter of 0.05 mm to 0.1 mm.
